(19) United States
(12) Patent Application Publication
(10) Pub. No.: US 2025/0164626 A1
(43) Pub. Date: May 22, 2025

(54) SPEED OF LIGHT MEASUREMENT USING FEEDBACK OF A PULSED LASER

(71) Applicant: King Fahd University of Petroleum and Minerals, Dhahran (SA)

(72) Inventor: Abdulaziz Mohammed Aljalal, Dhahran (SA)

(73) Assignee: King Fahd University of Petroleum and Minerals, Dhahran (SA)

(21) Appl. No.: 18/952,818

(22) Filed: Nov. 19, 2024

Related U.S. Application Data
(60) Provisional application No. 63/600,984, filed on Nov. 20, 2023.

(51) Int. Cl. G01S 11/12

(52) U.S. Cl. CPC G01S 11/12

(57) ABSTRACT

Methods and systems for determining the speed of light by utilizing optical feedback from a laser diode include a laser diode mounted at a distance from a linear stage, with a beamsplitter positioned at an initial location along the stage. The laser diode generates a variably pulsed laser beam that is split by the beamsplitter into two portions. The first portion is reflected back to the laser diode, inducing stimulated amplification, while the second portion is detected by a photodetector. The photodetector measures the optical intensity and generates an amplified electrical signal. A data acquisition system records the frequency at which the laser power peaks, indicating resonance conditions. The beamsplitter is subsequently moved to a second position, and a new peak frequency is detected. Based on the measured frequencies and positions, the speed of light is calculated with high precision.

### CROSS REFERENCE TO RELATED APPLICATIONS

The present application claims the benefit of priority to U.S. Prov. App. No. 63/600,984, entitled “Speed of Light Measurement Using Feedback of a Pulsed Laser”, filed on Nov. 20, 2023, and incorporated herein by reference in its entirety.

### STATEMENT REGARDING PRIOR DISCLOSURE BY THE INVENTORS

Aspects of this technology are described in an article “Speed of light measurement with a picosecond diode laser and a voltage-controlled oscillator”, published in American Journal of Physics, Vol. 90, pp 935-939, which is incorporated herein by reference in its entirety. Aspects of this technology are described in an article “Measuring the speed of light using optical feedback from a picosecond diode laser,” Am. J. Phys., Vol. 90, 211-217 (2022), which is incorporated herein by reference in its entirety.

### STATEMENT OF ACKNOWLEDGEMENT

Support provided by the Deanship of Scientific Research at the King Fahd University of Petroleum and Minerals (KFUPM), Riyadh, Saudi Arabia through Project No. RG181004 is gratefully acknowledged.

### BACKGROUND

### Technical Field

The present disclosure is directed to measurement of the speed of light using feedback from pulsed diode lasers triggered by a voltage-controlled oscillator.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The measurement of the speed of light is essential for understanding electromagnetic wave propagation and has broad applications across physics, engineering, and telecommunications. Traditional methods to measure the speed of light have evolved from early techniques using rotating mirrors and lenses to modern approaches leveraging advanced electronic components. One contemporary method uses pulsed diode lasers to measure the time taken for a laser pulse to reflect from a target and return. This time-of-flight method offers precise measurements of light speed in various media, such as air, water, and vacuum. Another method involves using fixed-frequency oscillators to trigger laser pulses and detect optical feedback from an external object.

Using pulsed diode lasers in these experiments provides notable precision, especially when paired with high-frequency oscillators that enhance timing control. Such setups generally involve aligning optical components, including lasers, beamsplitters, and mirrors, to produce and analyze feedback signals, enabling accurate speed-of-light measurements without requiring high-bandwidth oscilloscopes or complex detectors, making the setup relatively simple and cost-effective.

However, these laser-based methods face certain challenges. The accuracy of measurements depends on the precise positioning of optical components such as beamsplitters and mirrors, as well as on the stability of laser pulse timing. In fixed-frequency systems, exact positioning is crucial, as even minor deviations can lead to measurement errors. Motorized linear stages are often used to achieve precise positioning, although they increase both cost and complexity.

Additionally, some fixed-frequency oscillator-based methods require iterative positioning of the beamsplitter until optical feedback is observed at specific positions, which is cumbersome and time-intensive. This iterative process limits the practicality and compactness of the system, making it less suitable for educational or simpler laboratory settings.

CN103364090A discloses a device designed to measure the propagation phase velocity of an ultrashort pulse laser in various media. The laser beam is split into two separate paths, which are subsequently recombined and directed to two precision detectors. The detectors analyze the beams to determine the phase difference between them. However, this measurement requires an optical delay platform system to adjust the optical path difference, and utilizes two separate detectors to measure the phase difference rather than the speed of light.

WO2019116384A1 discloses measuring the speed of light within a liquid medium. The measurement process involves splitting a laser beam, directing it through a beamsplitter, measuring the pulse lag in the time domain, and calculating the speed of light based on the pulse lag and refractive index of the liquid medium. However, this measurement technique does not determine the speed of light by identifying peak frequencies at which constructive interference of a pulsed laser beam occurs.

Existing approaches that employ fixed-frequency oscillators are well-documented in the literature. For example, some known techniques involve triggering a pulsed diode laser with a stable oscillator and measuring the resultant optical feedback. However, these techniques are often limited by their need for extensive calibration and precise component positioning, which can hinder the applicability of the configuration in smaller-scale laboratory environments. Additionally, the reliance on mechanical adjustments to achieve the feedback condition presents logistical and financial challenges, especially in educational or budget-constrained setups.

Therefore, there is a need for an improved method and system for measuring the speed of light that reduces the dependency on precise physical adjustments, lowers the overall cost of the system, and simplifies the process of obtaining accurate measurements. Accordingly, the present disclosure describes methods and systems for measuring the speed of light with accurate feedback detection without requiring extensive component repositioning, thus providing a more accessible and cost-effective solution for both educational and research applications.

### SUMMARY

In an exemplary embodiment a method for determining the speed of light includes mounting, at a distance X₀ from a linear stage, a laser diode, mounting, at a first location X₁ on the linear stage, a beamsplitter, and mounting a photodetector at a distance Xₚ from the beamsplitter. The beamsplitter is located between the laser diode and the photodetector and a center of the beamsplitter is in line with an eye of the photodetector. The method further includes connecting the laser diode to a laser driver, generating, by the laser driver, a current having a variable frequency pulse, driving, by the laser driver, the laser diode with the current having a variable frequency pulse, and generating, by the laser diode, a variably pulsed laser beam. The method further includes transmitting the variably pulsed laser beam to the beam splitter, splitting, by the beam splitter, the variably pulsed laser beam into a first portion which is reflected from the beam splitter and a second portion which passes through the beam splitter, receiving, by the laser diode, the first portion, receiving, by the eye of the photodetector, the second portion, measuring, by the photodetector, an optical intensity of second portion, and generating, by the photodetector, an electrical signal based on the optical intensity. The method further includes amplifying, by a transimpedance amplifier, the electrical signal, receiving, by a data acquisition (DAQ) system, the amplified electrical signal, detecting, by the data acquisition (DAQ) system, a frequency f₁ at which an average power of the variably pulsed laser beam peaks due to stimulated amplification, by the first portion reflected from the beamsplitter from the first location X₁, of the variably pulsed laser beam generated by the laser diode, moving the beamsplitter to a second location X₂, detecting, by the data acquisition (DAQ) system, a frequency f₂ at which the average power of the variably pulsed laser beam peaks due to stimulated amplification, by the first portion reflected from the beamsplitter from the second location X₂, of the variably pulsed laser beam generated by the laser diode, and calculating, by a computing device connected to the DAQ system, the speed of light v based on:

v=2(X₂−X₁)/(1/f₂−1/f₁).

In another exemplary embodiment, a system for determining the speed of light includes a linear stage, a laser diode mounted at a distance X₀ from the linear stage, wherein the laser diode is configured to generate a variably pulsed laser beam, a beamsplitter mounted at a first location X₁ on the linear stage, wherein the beamsplitter is configured to receive the variably pulsed laser beam from the laser diode, and a photodetector mounted at a distance Xₚ from the beamsplitter. An eye of the photodetector is configured to receive a portion of the variably pulsed laser beam from the beamsplitter. The system further includes a laser driver operatively connected to the laser diode. The laser driver is configured to generate a current having a variable frequency pulse. The laser diode is configured to receive the current having a variable frequency pulse, generate a variably pulsed laser beam and transmit the variably pulsed laser beam to the beam splitter. The beamsplitter is configured to split the variably pulsed laser beam into a first portion which is reflected from the beam splitter back to the laser diode and a second portion which passes through the beam splitter and is transmitted to the photodetector. The eye of the photodetector is configured to receive the second portion transmitted from the beamsplitter from the first location X₁. The photodetector is configured to measure an optical intensity of the second portion transmitted by the beamsplitter from the first location X₁ and generate a first electrical signal based on the optical intensity. The system further includes a transimpedance amplifier connected to the photodetector, wherein the transimpedance amplifier is configured to amplify the first electrical signal, a data acquisition (DAQ) system configured to receive the first amplified electrical signal and detect a frequency f₁ at which an average power of the variably pulsed laser beam peaks due to stimulated amplification, by the first portion reflected from the beamsplitter from the first location X₁, of the variably pulsed laser beam generated by the laser diode, and a computer system operatively connected to the DAQ system, wherein the computer system is configured to store the first location X₁ and the frequency f₁. The beamsplitter is configured to be moved to a second location X₂. The beamsplitter at the second location X₂ is configured to split the variably pulsed laser beam into a first portion which is reflected from the beam splitter back to the laser diode and a second portion which passes through the beam splitter and is transmitted to the photodetector. The eye of the photodetector is configured to receive the second portion transmitted by the beamsplitter from the second location X₂. The photodetector is configured to measure an optical intensity of the second portion transmitted by the beamsplitter from the second location X₂ and generate a second electrical signal based on the optical intensity. The transimpedance amplifier is configured to amplify the second electrical signal. The data acquisition (DAQ) system is further configured to receive the amplified second electrical signal and detect a frequency f₂ at which an average power of the variably pulsed laser beam peaks due to stimulated amplification, by the first portion reflected from the beamsplitter from the second location X₂, of the variably pulsed laser beam generated by the laser diode. The computer system is configured to store the second location X₂ and the frequency f₂, and the computer system is further configured to calculate the speed of light v based on:

$$v = 2 ( {X}_{2} - {X}_{1} ) / ( 1 / {f}_{2} - 1 / {f}_{1} ) .$$

In another exemplary embodiment, a system includes a linear stage, a laser diode mounted at a distance X₀ from the linear stage, and a laser driver operatively connected to the laser diode. The laser driver is configured to generate a current having a variable frequency pulse. The laser diode is configured to receive the current having a variable frequency pulse, generate a variably pulsed laser beam and transmit the variably pulsed laser beam. The system includes a mirror mounted at a first location X₁ on the linear stage. The mirror is configured to receive the variably pulsed laser beam from the laser diode and reflect a portion of the variably pulsed laser beam back to the laser diode as feedback. The feedback generates stimulated amplification of the variably pulsed laser beam. The system further includes a photodetector configured to receive the amplified variably pulsed laser beam from the laser diode. The photodetector is configured to measure an optical intensity of the second portion transmitted by the mirror from the first location X₁ and generate a first electrical signal based on the optical intensity. The system further includes a transimpedance amplifier connected to the photodetector. The transimpedance amplifier is configured to amplify the first electrical signal. The system further includes a data acquisition (DAQ) system configured to receive the first amplified electrical signal and detect a frequency f₁ at which an average power of the variably pulsed laser beam peaks due to stimulated amplification, by the first portion reflected from the mirror from the first location X₁, of the variably pulsed laser beam generated by the laser diode, and a computer system operatively connected to the DAQ system. The computer system is configured to store the first location X₁ and the frequency f₁. The mirror is configured to be moved to a second location X₂ on the linear stage. The eye of the photodetector is configured to receive the second portion transmitted by the mirror from the second location X₂. The photodetector is configured to measure an optical intensity of the second portion transmitted by the mirror from the second location X₂ and generate a second electrical signal based on the optical intensity. The transimpedance amplifier is configured to amplify the second electrical signal. The data acquisition (DAQ) system is further configured to receive the amplified second electrical signal and detect a frequency f₂ at which an average power of the variably pulsed laser beam peaks due to stimulated amplification, by the first portion reflected from the mirror from the second location X₂, of the variably pulsed laser beam generated by the laser diode. The computer system is configured to store the second location X₂ and the frequency f₂. The computer system is further configured to calculate the speed of light v based on:

$$v = 2 ( {X}_{2} - {X}_{1} ) / ( 1 / {f}_{2} - 1 / {f}_{1} ) .$$

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a compact optical feedback configuration using a beamsplitter, according to certain embodiments.

FIG. 1B illustrates an optical feedback configuration using a reflective mirror setup, according to certain embodiments.

FIG. 1C illustrates a hybrid optical feedback configuration, according to certain embodiments.

FIG. 2 an optical feedback system for determining a speed of light, according to certain embodiments.

FIG. 3 illustrates a reshaping and dividing circuit, according to certain embodiments.

FIG. 4 illustrates a graph representing a relationship between a detector signal and a setting of a laser intensity potentiometer on a laser driver, according to certain embodiments.

FIG. 5 illustrates a graphical representation of an average power of a laser output, measured as a function of pulse frequency, according to certain embodiments.

FIG. 6 illustrates a graph representing a relationship between a linear stage position and a pulse frequency at which a feedback signal reaches its peak, according to certain embodiments.

FIG. 7 is an illustration of a non-limiting example of details of computing hardware used in a computing device, according to certain embodiments.

FIG. 8 is an exemplary schematic diagram of a data processing system used within the computing device, according to certain embodiments.

FIG. 9 is an exemplary schematic diagram of a processor used with the computing device, according to certain embodiments.

FIG. 10 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

The present disclosure relates to a method and systems for determining the speed of light using a compact and efficient optical setup. Conventional techniques for measuring the speed of light require either lengthy measurement paths or high-speed detectors and oscilloscopes, which can be expensive and cumbersome in laboratory environments. Conventional solutions often involve complex setups to measure phase differences or time lags in the laser beam, with separate detectors and precision optical delay systems, which focus on phase velocity or require knowledge of the refractive index of the medium.

The present disclosure uses a laser diode that generates variably pulsed laser beams, beamsplitters and/or mirrors, and a photodetector. By implementing optical feedback from the laser diode, the system induces a peak in average power at specific frequencies where constructive interference occurs. The beamsplitter is moved between two distinct positions, allowing the system to detect and record the pulse frequencies at which feedback-induced resonance peaks appear. Using these measured frequencies and positioning the beamsplitter, the system performs precision calculation of the speed of light without the need for extended distances or high-speed measurement devices.

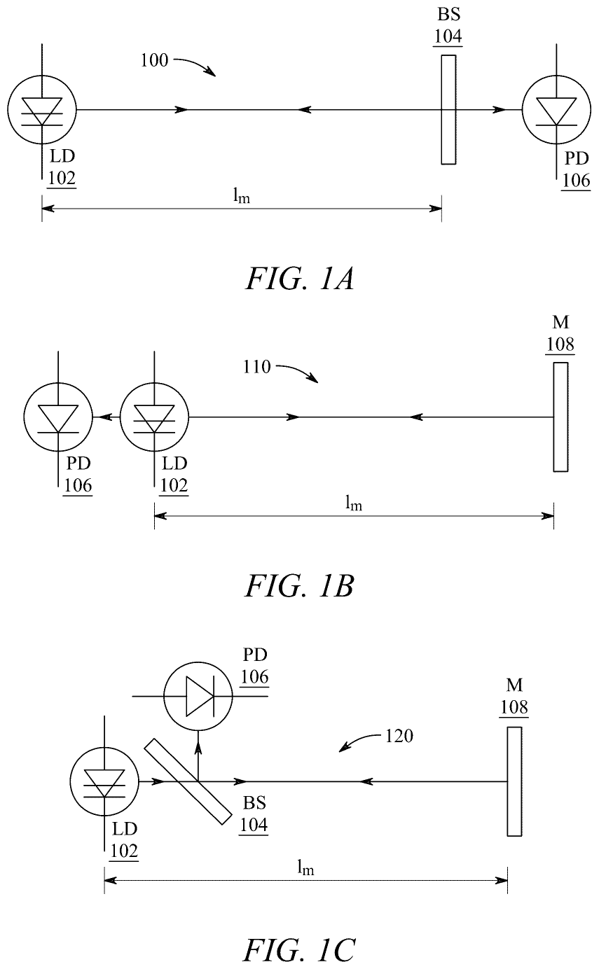

FIG. 1A illustrates a first compact optical feedback configuration 100. The first compact optical feedback configuration 100 is implemented for measuring the speed of light without requiring high-speed detectors or oscilloscopes. In this configuration, a pulsed laser diode (LD) 102 is mounted on a linear stage and positioned at a calibrated distance 1ₘ from a beamsplitter (BS) 104. The beamsplitter 104 is configured to split an incident variably pulsed laser beam emitted by the laser diode (LD) 102 into two portions, a first portion that is directed back toward the LD 102, creating optical feedback within the laser cavity, and a second portion that is transmitted toward a photodiode 106. The photodiode 106 is positioned to capture the transmitted portion of the laser beam, so that the feedback-induced intensity variations are detected. Such configuration achieves precise alignment and controlled measurement of optical feedback at various beamsplitter positions along the linear stage, facilitating accurate speed of light calculations based on feedback modulation.

FIG. 1B shows an optical feedback configuration 110 for observing optical feedback using a reflective mirror setup. In the present configuration, the LD 102 is positioned at a defined distance 1ₘ from a mirror (M) 108 aligned along the linear stage. The mirror 108 reflects a portion of the variably pulsed laser beam back into the LD 102, generating feedback without the need for a beamsplitter. The photodiode 106 is placed adjacent to the LD 102 to monitor the intensity of the reflected laser beam, as a result, power fluctuations caused by optical feedback can be monitored. The mirror-based configuration renders a feedback observation, eliminating the transmission path required in the beamsplitter configuration.

FIG. 1C presents a hybrid optical feedback configuration 120 combining elements of the beamsplitter, as described with reference to FIG. 1A, and a mirror setup, as described with reference to FIG. 1B. In the present configuration, the LD 102 emits a variably pulsed laser beam directed toward the beamsplitter 104 mounted at an intermediate position along the linear stage. The beamsplitter 104 is oriented at an angle, splitting the laser beam into two distinct paths, one path directs a portion of the beam toward the photodiode 106 for intensity measurement, while the second path directs the remaining portion toward the mirror 108. The mirror 108 reflects the laser beam back through the beamsplitter 104 to the LD 102, creating a closed-loop feedback path. This configuration allows for precise control over the optical feedback parameters by adjusting both the beamsplitter position and mirror alignment, thus facilitating high-accuracy measurements of light speed.

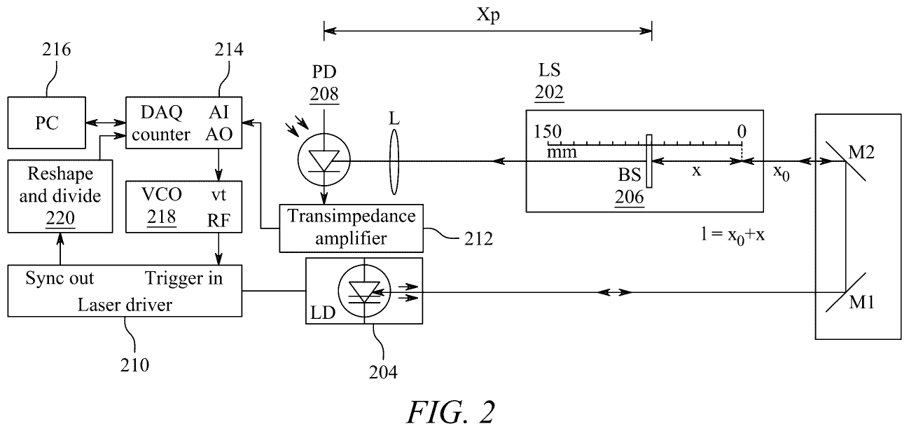

FIG. 2 illustrates an optical feedback system 200 for determining the speed of light, comprising a linear stage 202, a laser diode 204, a beamsplitter 206, a photodetector 208, a laser driver 210, a transimpedance amplifier 212, a data acquisition (DAQ) system 214, a computer 216, a voltage-controlled oscillator (VCO) 218\ and mirrors M1 and M2.

The laser diode 204 is mounted at a distance X₀ from a linear stage 202. The linear stage is a precision mechanical device implemented for controlled, linear motion along a single axis. The linear stage is used to adjust the position of the beamsplitter relative to the laser diode and photodetector with high accuracy. By moving the beamsplitter to different, predefined locations along the linear stage, such as positions X₁ and X₂, the system measures and compares the frequencies at which resonance peaks occur. However, the distance from the laser diode 204 and the beamsplitter cannot be directly measured, as there is a small segment of the laser beam pathway which is within the housing of the laser diode 204. Therefore, the measurement must be performed at two different locations of the beamsplitter in order to cancel this small distance from the measurement during the processing.

The laser diode 204 is configured to generate a variably pulsed laser beam, providing ultra-short pulses for high-resolution temporal measurements. In one example, the laser diode 204 is a picosecond laser diode, generating laser pulses with a full width at half maximum (FWHM) of approximately 50 picoseconds, which corresponds to a spatial pulse width of about 15 mm. The laser diode 204 is operatively connected to a laser driver 210, which supplies a current with a variable frequency pulse controlled by the VCO 218. In one aspect, the oscillator frequency is adjustable, with a central frequency of approximately 80 MHz. The laser diode 204 is configured to generate a variable-frequency trigger signal. The trigger signal controls the emission frequency of the laser pulses from the laser diode 204, achieving frequency modulation as required for the optical feedback system.

The beamsplitter 206 is mounted on the linear stage 202 at a distance X₁ on the linear stage. The beamsplitter 206 is configured to receive the variably pulsed laser beam generated by the laser diode 204 and split it into two portions. A first portion of the laser beam is reflected back toward the laser diode 204, creating an optical feedback loop, while a second portion is transmitted through a lens L toward a photodetector 208. The beamsplitter 206 thus achieves feedback-based resonance detection by splitting the laser beam in a controlled manner. The placement of the beamsplitter 206 on the linear stage 202 allows for fine-tuned positioning, that is helpful for adjusting the feedback path to observe different resonance conditions at various distances.

The photodetector 208 is mounted at a distance Xₚ from the beamsplitter 206. The photodetector 208 is positioned to receive a portion of the laser beam transmitted from the beamsplitter 206 and is configured to detect the optical intensity of the transmitted laser pulses. Upon receiving the transmitted beam, the photodetector 208 converts the optical signal into an electrical signal that reflects the intensity of the detected light.

The photodetector 208 includes an optical detection area, referred to as the “eye” of the photodetector, which is configured to receive the second portion transmitted from the beamsplitter 206. Upon receiving this portion, the photodetector 208 measures the optical intensity of the transmitted laser pulse and generates a corresponding electrical signal, referred to as the first electrical signal, based on the detected intensity.

The first electrical signal generated by the photodetector 208 is then transmitted to a connected transimpedance amplifier 212. A transimpedance amplifier is an electronic component that is used for converting a current output from a photodetector into a corresponding voltage signal. When a photodetector receives the light transmitted through a beamsplitter, the transimpedance amplifier generates an electrical current proportional to the intensity of the detected light. The current signal, however, is often too small to be processed directly by data acquisition systems or other measurement electronics.

The transimpedance amplifier 212 is configured to amplify the first electrical signal, converting the small current output from the photodetector 208 into a stronger voltage signal suitable for further processing. The amplified signal is subsequently transmitted to the data acquisition (DAQ) system 214, which is configured to detect and record the frequency f₁ at which the average power of the variably pulsed laser beam peaks due to stimulated amplification in the feedback loop. The peak in average power is achieved as the first portion of the laser beam reflected from the beamsplitter 206 at the first location X₁ resonates with the variably pulsed laser beam generated by the laser diode 204. The DAQ system 214 transmits the recorded frequency f₁ to a computer system 216, where both the first location X₁ and frequency f₁ are stored for subsequent analysis.

The beamsplitter 206 is further configured to be moved along the linear stage 202 to a second location X₂. When positioned at the second location X₂, the beamsplitter 206 performs a similar function, splitting the variably pulsed laser beam into two portions: the first portion, which is reflected back to the laser diode 204 to maintain the optical feedback loop, and the second portion, which is transmitted through the beamsplitter 206 and directed toward the photodetector 208. The eye of the photodetector 208 is configured to receive this second portion transmitted by the beamsplitter 206 from the second location X₂, allowing the photodetector 208 to measure the optical intensity of the transmitted pulse from the new position.

Upon receiving the transmitted portion from the second location X₂, the photodetector 208 generates a second electrical signal based on the optical intensity detected at this location. The second electrical signal is amplified by the transimpedance amplifier 212, as previously described, and the amplified signal is transmitted to the DAQ system 214. The DAQ system 214 is further configured to detect the frequency f₂ at which the average power of the variably pulsed laser beam peaks when the first portion of the beam, reflected from the beamsplitter 206 at the second location X₂, aligns with the feedback loop established by the laser diode 204.

The system includes a voltage-controlled oscillator (VCO) 218 configured to modulate the frequency of the pulses generated by the laser diode 204. The VCO 218 receives a control voltage from the DAQ system 214, enabling fine adjustments to the pulse frequency of the laser diode 204. Such modulation capability allows for the precise tuning of the laser pulse frequency, which is necessary for identifying the resonance frequencies at different feedback path lengths. By scanning the frequency range, the system 200 can locate the resonance peaks corresponding to specific distances, facilitating accurate speed of light measurements.

The laser driver 210 is operatively connected to both the laser diode 204 and the VCO 218, providing the necessary power and control signals to operate the laser diode 204. The laser driver 210 also includes a synchronization output (Sync Out) configured to emit timing signals for the laser pulses. The synchronization signals are processed through a reshape and divide circuit 220, which converts them into TTL-compatible signals suitable for the DAQ system 214.

The DAQ system 214 is configured to receive and record the amplified signals from the photodetector 208, as well as to control the VCO 218. The DAQ system 214 captures the frequency at which feedback-induced resonance occurs, identifying peak intensities that indicate optimal feedback conditions. The system stores this data for further analysis, with the position of the beamsplitter 206 and corresponding frequency values transmitted to an external computer 216. The computer 216 is configured to analyze the recorded data, calculating the speed of light v based on resonance conditions using the equation:

v=2(X₂−X₁)/(1/f₂−1/f₁) (1)

In another exemplary aspect of the system for determining the speed of light, the system 200 comprises a linear stage 202 on which various components are precisely positioned to facilitate the measurement process. A laser diode 204 is mounted at a fixed distance X₀ from the linear stage 202, and it is operatively connected to a laser driver 210. The laser driver 210 generates a current with a variable frequency pulse, which the laser diode 204 receives, to produce a variably pulsed laser beam. The pulsed laser beam is directed towards a dual-mirror setup mounted at a first location X₁ on the linear stage 202. The dual-mirror setup reflects a portion of the laser beam back to the laser diode 204, providing feedback that induces stimulated amplification in the laser beam.

The dual-mirror setup includes Mirror M1 and Mirror M2. Mirror M1 is mounted at a first location X₁ on the linear stage 202 and is positioned to receive the variably pulsed laser beam emitted from the laser diode 204. Mirror M1 reflects a portion of this pulsed laser beam back toward the laser diode 204, creating optical feedback. The feedback results in stimulated amplification of the laser beam within the laser diode 204, producing a resonance effect that is measured at specific frequencies. The constructive interference induced by this feedback enables the system to detect peak frequencies at which the average power of the laser beam is maximized, which is recorded as frequency f₁ by the data acquisition (DAQ) system 214.

Mirror M2 is positioned on the opposite side of the linear stage 202 relative to M1 and serves as a second location X₂ for reflecting the pulsed laser beam. After the initial measurements are taken with mirror M1 at location X₁, the mirror M2 at location X₂ is used to reflect a portion of the pulsed laser beam back to the laser diode 204. Similar to mirror M1, mirror M2 induces constructive interference at a different frequency due to its distinct position along the linear stage 202.

A photodetector 208 is positioned to receive the amplified, variably pulsed laser beam emitted from the laser diode 204. The photodetector 208 is configured to measure the optical intensity of the beam as it passes through, specifically detecting the portion of the beam reflected from the mirror 108 located at X₁. Upon receiving the reflected laser beam, the photodetector 208 generates an electrical signal proportional to the measured optical intensity. The initial electrical signal is then amplified by a transimpedance amplifier 212 connected to the photodetector 208, converting the small current from the photodetector into a larger, more readable voltage signal.

The amplified signal is fed into a data acquisition (DAQ) system 214, which detects the frequency f₁ at which the average power of the laser beam peaks. The peak frequency is attributed to the constructive interference resulting from the feedback-induced amplification by the reflected portion of the laser beam from the mirror 108 positioned at location X₁. The DAQ system 214 records this frequency, and the location X₁ is stored within a computer system 216 that is operatively connected to the DAQ system 214.

The system further includes a mechanism for repositioning the mirror to a second location X₂ on the linear stage 202. At this new position, the mirror again reflects a portion of the pulsed laser beam back to the laser diode 204, creating a similar feedback effect. The photodetector 208 is configured to receive the reflected portion of the laser beam from the second position X₂ and to measure its optical intensity, generating a second electrical signal based on this intensity measurement. The transimpedance amplifier 212 amplifies this second electrical signal, which is subsequently processed by the DAQ system 214.

The DAQ system 214 records a second peak frequency f₂, which corresponds to the frequency at which constructive interference occurs due to the feedback effect from the new position X₂. The computer system 216 stores both the second location X₂ and the frequency f₂ detected at this position.

The computer system 216 uses the recorded frequencies f₁ and f₂, along with the corresponding mirror positions X₁ and X₂, to calculate the speed of light v using the formula:

$$v = 2 ( {X}_{2} - {X}_{1} ) / ( 1 / {f}_{2} - 1 / {f}_{1} )$$

The distance X₀ includes a portion of the laser diode, which is within a housing of the laser diode, where the computing device is configured to calculate the distance X₀ based on:

$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$

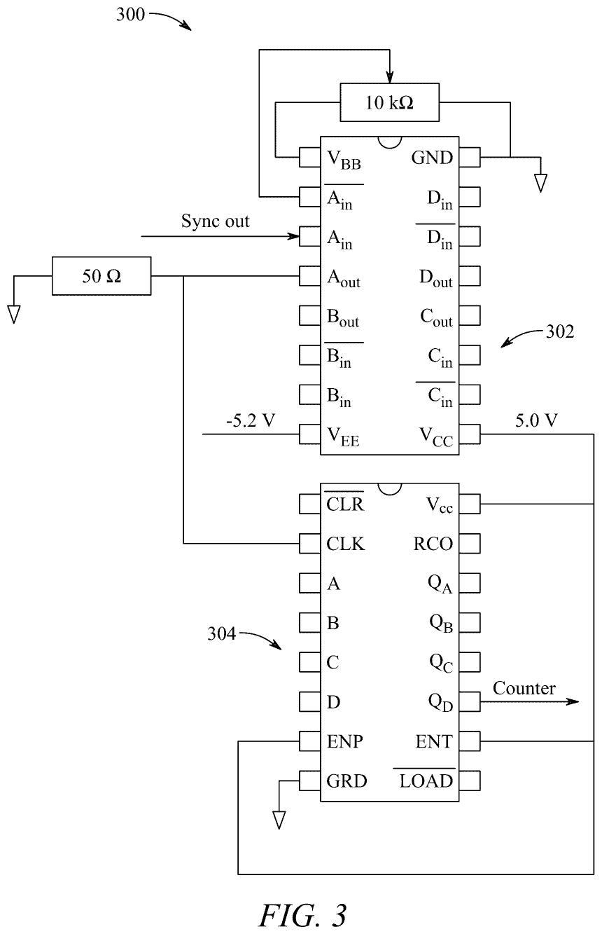

FIG. 3 illustrates a reshaping and dividing circuit 300 configured for converting the synchronization output signal of a laser driver using a nuclear instrument module (NIM), which converts standard to transistor-transistor logic (TTL) compatible signals. NIM was developed primarily for applications in nuclear and particle physics experiments. It is characterized by fast, negative-going pulses, designed to meet the high-speed and low-noise requirements typical of scientific instrumentation. In NIM signals, each pulse generally transitions from 0 volts (ground) down to a negative voltage, typically around −0.8 volts, to indicate a “low” or active state. In a non-limiting example, the nuclear instrument module is a NIM Module, manufactured by Kontron, America, Inc., Springfield, Ohio, United States of America. TTL is a widely adopted standard for digital circuits, including computer hardware and general-purpose electronics. TTL signals operate within a voltage range of 0 to +5 volts, where a “high” state is typically defined by voltages above approximately 2 volts, and a “low” state is below 0.8 volts. TTL is based on positive-going pulses, with 0 volts representing the “low” state and +5 volts representing the “high” state.

The reshaping and dividing circuit 300, also referred to as a circuit 300, is configured to divide the frequency synchronization output of the laser driver by selectable factors, allowing for division by 2, 4, 8, or 16. The reshaping and dividing circuit 300 is implemented for adapting the high-frequency signals generated by the laser driver to the frequency range and logic standards required for subsequent components, such as a data acquisition system or counter.

The reshaping and dividing circuit 300 includes two primary integrated circuits, an MECL-to-TTL translator 302 and a synchronous 4-bit binary counter 304. In a configuration of the circuit 300, the MECL-to-TTL translator 302 is implemented as a quad translator, model MC10H125, which is configured to receive the synchronization output (Sync Out) from the laser driver. The synchronization signal, initially output as a fast negative logic NIM signal, is applied to the differential input terminals Aᵢₙ of the translator 302. To achieve proper impedance matching and prevent pulse reflections, a 50-ohm resistor is connected in series with the Sync Out input line.

In a non-limiting example, the MECL-to-TTL translator 302 is a MC10H125 quad, manufactured by On Semiconductor, Phoenix, Arizona, United States of America. The MECL-to-TTL translator 302 converts the NIM-standard signal from the laser driver into a TTL-compatible signal by translating the fast negative logic pulses into positive logic pulses at standard TTL voltage levels. The translated signal is output through the Aₒᵤₜ terminals, providing a TTL-compatible pulse stream with a frequency matching a synchronization output of the original laser driver. Additionally, a 10 kΩ potentiometer is used as a voltage divider connected to the differential input, providing precise bias control for the input signal to ensure stable and accurate translation.

The output from the translator 302 is subsequently directed to a synchronous 4-bit binary counter 304. The counter 304 receives the TTL-compatible signal from the MECL-to-TTL translator 302 at its clock (CLK) input terminal. The binary counter 304 is configured to divide the frequency of the incoming TTL signal by a selectable factor. The selectable division is accomplished by programming the counter 304 to output pulses at every second, fourth, eighth, or sixteenth clock pulse received, thereby providing divided frequencies as required by downstream components.

The counter 304 outputs the divided frequency signals through its output terminals QA, QB, QC, and QD, which represent the divided pulse stream. These output signals are directed to the counter 304 or data acquisition system input, enabling frequency counting or timing analysis of the divided pulse stream.

The experimental setup utilized specific component models, selected based on their availability within the laboratory, although alternative, cost-effective models may be substituted if required. The diode laser, referenced as DL, is a commercial picosecond laser system comprising a laser head (for example, model LDH-P-C-650, manufactured by PicoQuant, 54 Kane Street, West Springfield, MA 01119, United States of America) and a driver unit for the laser head (model PDL 800-B, developed by PicoQuant, 54 Kane Street, West Springfield, MA 01119, United States of America). The laser system emits a collimated visible beam at a wavelength of 657 nm, with pulses of approximately 50 picoseconds at repetition rates reaching up to 80 MHz, delivering an average output power of up to 6 mW.

The voltage-controlled oscillator (VCO) (for example, model CRBV55CL-0072-0076 manufactured by Crystek Corporation, 16850 Oriole Road Fort Myers, Florida 33912, United States of America), operates within a nominal frequency range of 72 to 76 MHz and requires a tuning voltage between 0.3 and 3.3 volts. The optical alignment system includes two mirrors (for example, model BB1-E02, manufactured by Thorlabs, 43 Sparta Ave Newton, New Jersey 07860, United States of America) and a 50/50 beamsplitter (for example, model BSW10, manufactured by Thorlabs), each mounted on kinematic mirror mounts (for example, model KM100, manufactured by Thorlabs) to ensure precise positioning.

The linear stage, identified as LS, is a motorized unit (for example, model NST150/M, manufactured by Thorlabs) with a travel length of 150 mm, powered by a stepper motor driver (for example, model DRV8824, manufactured by Pololu corporation, 920 Pilot Road in Las Vegas, Nevada 89119, United States of America). For simplified configurations, a manual linear stage may be used in place of the motorized version. The photodetector, designated as PD (for example, model DET36A, Thorlabs), features an active detection area of 3.6 mm×3.6 mm, with its output current amplified by a transimpedance amplifier (for example, model DLPCA-200, Femto corporation, 220 Davidson Ave, Suite 101, Somerset, New Jersey 08873, United States of America). Given the slow response requirements of the experiment, a properly valued resistor can substitute the transimpedance amplifier to prevent saturation of the detector.

The DAQ (for example, model USB-6366 from National Instruments Corporation, 11500 North Mopac Expressway, Austin, Texas, 78759 United States of America), operates in conjunction with LabVIEW software (developed by National Instruments) to control the VCO, manage the linear stage movement, count pulses from the reshaping and dividing circuit, and monitor a voltage output of the photodetector.

Table 1 describes a bill of material corresponding to the setup illustrated by FIG. 3, where,
^{a} A homemade picosecond diode laser can be built for a few hundred dollars.
^{b} The cost of unmounted oscillator is $30.
^{c} The experiment can be carried out with a manual linear stage or with no linear stage.
^{d} Any data acquisition device capable of measuring frequency up to 5 MHz such as NI USB-6210, which costs about $900.

TABLE 1
Bill of material

| Item | Description | Make | Price |
|---|---|---|---|
| 1 | Picosecond laser | Head LDH-P-C-650, PicoQuant Driver | $10,000^{a} |
| | | PDL 800-B, PicoQuant | |
| 2 | Voltage-controlled | CRBV55CL-0072-0076, Crystek | $130^{b} |
| | oscillator | corporation | |
| 3 | Photodiode | DET36A, Thorlabs | $130 |
| 4 | Linear stage | NST150/M, Thorlabs | $2,500^{c} |
| 5 | Data acquisition device | USB-6366, National Instruments | $7,700^{d} |
| 6 | Stepper motor driver | DRV8824, Pololu | $10 |
| 7 | Kinematic mirror | KM100, Thorlabs | $40 × 3 |
| | mounts | | |
| 8 | Beamsplitter | BSW10, Thorlabs | $100 |
| 9 | Mirrors | BB1-E02, Thorlabs | $80 × 2 |

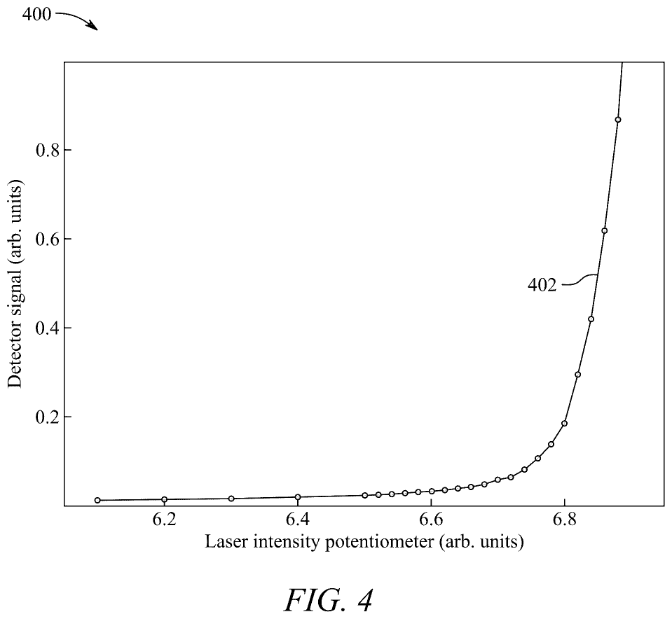

FIG. 4 illustrates a graph 400 representing the relationship between the detector signal and the setting of the laser intensity potentiometer on the laser driver. The horizontal axis represents the potentiometer setting in arbitrary units, which controls the intensity of the laser, while the vertical axis represents the detector signal output, also in arbitrary units.

The graph 400 is used to determine the threshold setting of the laser, a step prior to collecting data for the speed of light measurement. The threshold is the point at which the laser begins to emit a detectable level of power, indicated here by a rapid increase in detector signal as the potentiometer setting approaches 6.8. Below this threshold, the detector signal remains relatively low, as the laser operates with insufficient gain to produce significant output. As the potentiometer setting increases past this threshold, the detector signal rises sharply, reflecting the onset of measurable laser power output.

In preparation for the main experiment, the threshold setting is identified to optimize the laser for feedback measurement while operating close to, but below, the threshold. The configuration renders a narrow pulse frequency range over which optical feedback can be accurately observed. By maintaining the laser slightly below the threshold, the pulse frequency range becomes narrow, resulting in precise determination of the pulse frequency that maximizes the power.

The potentiometer adjustment is performed with the laser operating in pulsed mode at a frequency of approximately 73 MHz. The detector signal shown in FIG. 4 is the time-averaged output over multiple laser pulses, which is directly proportional to the average power of the laser beam. The detector signal is derived from the photodetector (PD), which is sensitive to variations in the laser intensity, allowing for the identification of operational threshold of the laser as the potentiometer setting is varied.

Table II presents the average and standard deviation of pulse frequency measurements taken 100 times across varying counting durations. The data indicates that, for counting times up to 500 milliseconds, the error in frequency measurement due to drift remains lower than the maximum potential error caused by missing a single count within the specified counting duration.

TABLE II
Average and standard deviation for 100 pulse frequency
measurements for different counting times.

| | | Frequency | Maximum error |
|---|---|---|---|
| Counting | Frequency | standard | for missing one |
| time (ms) | average (MHz) | deviation (MHz) | count (MHz) |
| 0.1 | 75.008 | 0.064 | 0.16 |
| 1.0 | 75.0078 | 0.0016 | 0.016 |
| 10.0 | 75.00798 | 0.00043 | 0.0016 |
| 20.0 | 75.00793 | 0.00023 | 0.0008 |
| 50.0 | 75.00789 | 0.00015 | 0.00032 |
| 100.0 | 75.007822 | 0.000055 | 0.00016 |
| 500.0 | 75.007759 | 0.000030 | 0.000032 |

The reshaping and dividing circuit divides the original frequency of 75 MHz by 16.

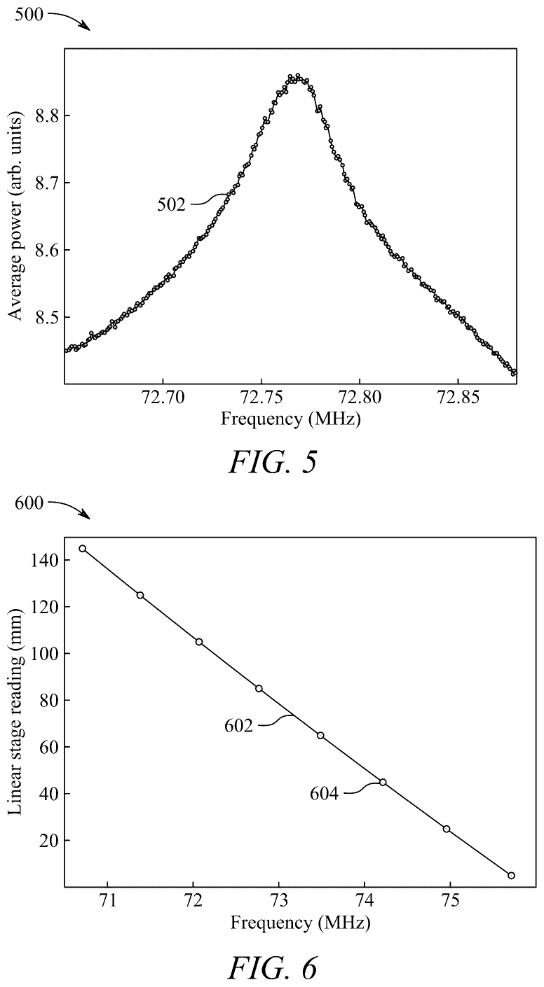

FIG. 5 illustrates a graphical representation 500 of the average power of the laser output, measured as a function of pulse frequency. The graph 500 represents an output of the photodetector, illustrating how an average power of the laser varies with frequency when feedback conditions are met. The frequency axis indicates the pulse frequency in megahertz (MHz), while the vertical axis displays the average power in arbitrary units, as measured by the photodetector. The curve 502 demonstrates a characteristic peak in average power of about 72.75 MHz. The peak results from the optical feedback process in which a portion of the emitted pulse is reflected back into the laser cavity by the beamsplitter, causing an overlap between the generated and reflected pulses.

The width of the feedback-induced power peak can be predicted based on Eq. (1), which relates the feedback disturbance to the overlap between the generated and reflected pulses. Specifically, for pulse frequencies around 73 MHz and a pulse duration of approximately 50 picoseconds, the disturbance width is estimated by Eq. (2) as approximately 1 MHz. The width reflects the nonlinear nature of the feedback process, where the average laser power disturbance depends on the degree of alignment between the emitted and reflected pulses. In one implementation, a full width at half maximum is Δt˜50ps, thus the disturbance is measured for lengths l within the range Δl=vΔt. From Eq. (1), with f˜73 MHz, the m=1 feedback disturbance would have a frequency disturbance Δl given by:

$$Δ f = \frac{v}{2} \frac{1}{{l}_{1} - v Δ t} - \frac{v}{2} \frac{1}{{l}_{1} + v Δ t} \approx 4 {f}^{2} Δ t \approx 1 MHz \qquad ( 2 )$$

The behavior of the laser near and below its threshold was observed to influence the range over which power disturbances are detectable. As shown in FIG. 5, the peak of the feedback signal was determined to be within 0.002 MHz when the laser was operated below the threshold and the potentiometer setting was optimized to reduce feedback disturbance. The setup thus resulted in precise measurement of the feedback peak frequency, for calculating the speed of light based on the feedback resonance conditions at different positions of the beamsplitter along the linear stage.

FIG. 6 illustrates a graph 600 showing the relationship between the linear stage position and the pulse frequency at which the feedback signal reaches its peak. The graph 600 illustrates the speed of light by analyzing the resonance frequencies at varying distances between the laser and the beamsplitter. The horizontal axis represents pulse frequency in MHz, while the vertical axis indicates the linear stage reading in millimeters, which corresponds to the distance x that the beamsplitter has been moved along the linear stage from an initial offset distance x₀.

The data points in FIG. 6 are fitted by both a nonlinear model, indicated by curve 602, and a linear model, indicated by curve 604. The nonlinear fit provides a more accurate representation of the frequency-position relationship, with the fit given by the equation:

$$x = - {x}_{0} + \frac{v / 2}{f} \qquad ( 3 )$$

where x₀ represents the initial offset distance, and v is the calculated speed of light based on the observed feedback frequencies.

From the nonlinear fit, the offset distance x₀ is determined to be approximately 1.974 m, and the speed of light v is calculated as (2.996±0.001)×10⁸ m/s. This calculated value closely aligns with the accepted speed of light in air, 2.997×108 m/s, for the wavelength of 657 nm. The error bars associated with the frequency and position measurements are not shown, as they are too small to be visually represented on the scale of this plot. Nevertheless, the primary sources of error include positional accuracy affected by the repeatability of the linear stage (±0.001 mm) and frequency measurement precision limited by peak detection accuracy (±0.002 MHz).

Various embodiments of the present disclosure are described through FIG. 1A to FIG. 6. In one exemplary embodiment, a method for determining the speed of light includes mounting, at a distance X₀ from a linear stage, a laser diode, mounting, at a first location X₁ on the linear stage, a beamsplitter, and mounting a photodetector at a distance Xₚ from the beamsplitter. The beamsplitter is located between the laser diode and the photodetector and a center of the beamsplitter is in line with an eye of the photodetector. The method further includes connecting the laser diode to a laser driver, generating, by the laser driver, a current having a variable frequency pulse, driving, by the laser driver, the laser diode with the current having a variable frequency pulse, and generating, by the laser diode, a variably pulsed laser beam.

The method further includes transmitting the variably pulsed laser beam to the beam splitter, splitting, by the beam splitter, the variably pulsed laser beam into a first portion which is reflected from the beam splitter and a second portion which passes through the beam splitter, receiving, by the laser diode, the first portion, receiving, by the eye of the photodetector, the second portion, measuring, by the photodetector, an optical intensity of second portion, and generating, by the photodetector, an electrical signal based on the optical intensity. The method further includes amplifying, by a transimpedance amplifier, the electrical signal, receiving, by a data acquisition (DAQ) system, the amplified electrical signal, detecting, by the data acquisition (DAQ) system, a frequency f₁ at which an average power of the variably pulsed laser beam peaks due to stimulated amplification, by the first portion reflected from the beamsplitter from the first location X₁, of the variably pulsed laser beam generated by the laser diode, moving the beamsplitter to a second location X₂, detecting, by the data acquisition (DAQ) system, a frequency f₂ at which the average power of the variably pulsed laser beam peaks due to stimulated amplification, by the first portion reflected from the beamsplitter from the second location X₂, of the variably pulsed laser beam generated by the laser diode, and calculating, by a computing device connected to the DAQ system, the speed of light v based on:

$$v = 2 ( {X}_{2} - {X}_{1} ) / ( 1 / {f}_{2} - 1 / {f}_{1} ) .$$

In an aspect, the method includes calculating, by the computing device, the distance X₀ of the laser diode from the linear stage by:

$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$

In an aspect, a distance between the distance X₀ and the position Xₚ is greater than or equal to about one meter and less than or equal to about two meters for a variable frequency pulse centered at about 80 MHz.

In an aspect, the variably pulsed laser beam has pulse width of 50 picoseconds.

In an aspect, the method includes converting, by an analog-to-digital converter of the DAQ, the amplified second portion to a digital amplified second portion, and transmitting the digital amplified second portion to the computing device.

In an aspect, the method includes generating, by the DAQ system, a voltage output signal configured to control the frequency of the variable frequency pulse, receiving, at an input voltage terminal of the voltage controlled oscillator, the voltage output signal, generating, by the voltage controlled oscillator, a trigger output, and transmitting the trigger output to the laser driver.

In an aspect, the method includes generating, by the laser driver, a nuclear instrument module (NIM) sync signal, transmitting, by the laser driver, the NIM sync signal to a reshape and divide circuit configured to convert the NIM sync signal to a low voltage transistor-to-transistor logic (TTL) sync signal.

In an aspect, the method includes receiving, by a counter located in the DAQ, the TTL sync signal from the reshape and divide circuit; and triggering, by the counter, the analog-to-digital converter of the DAQ to transmit the digital amplified second portion to the computing device based on the TTL sync signal.

In another exemplary embodiment, a system for determining the speed of light includes a linear stage, a laser diode mounted at a distance X₀ from the linear stage, wherein the laser diode is configured to generate a variably pulsed laser beam, a beamsplitter mounted at a first location X₁ on the linear stage. The beamsplitter is configured to receive the variably pulsed laser beam from the laser diode. The system further includes a photodetector mounted at a distance Xₚ from the beamsplitter. An eye of the photodetector is configured to receive a portion of the variably pulsed laser beam from the beamsplitter. The system further includes a laser driver operatively connected to the laser diode. The laser driver is configured to generate a current having a variable frequency pulse. The laser diode is configured to receive the current having a variable frequency pulse, generate a variably pulsed laser beam and transmit the variably pulsed laser beam to the beam splitter.

The beamsplitter is configured to split the variably pulsed laser beam into a first portion which is reflected from the beam splitter back to the laser diode and a second portion which passes through the beam splitter and is transmitted to the photodetector. The eye of the photodetector is configured to receive the second portion transmitted from the beamsplitter from the first location X₁. The photodetector is configured to measure an optical intensity of the second portion transmitted by the beamsplitter from the first location X₁ and generate a first electrical signal based on the optical intensity.

The system further includes a transimpedance amplifier connected to the photodetector. The transimpedance amplifier is configured to amplify the first electrical signal. A data acquisition (DAQ) system configured to receive the first amplified electrical signal and detect a frequency f₁ at which an average power of the variably pulsed laser beam peaks due to stimulated amplification, by the first portion reflected from the beamsplitter from the first location X₁, of the variably pulsed laser beam generated by the laser diode, and a computer system operatively connected to the DAQ system. The computer system is configured to store the first location X₁ and the frequency f₁.

The beamsplitter is configured to be moved to a second location X₂. The beamsplitter at the second location X₂ is configured to split the variably pulsed laser beam into a first portion which is reflected from the beam splitter back to the laser diode and a second portion which passes through the beam splitter and is transmitted to the photodetector. The eye of the photodetector is configured to receive the second portion transmitted by the beamsplitter from the second location X₂. The photodetector is configured to measure an optical intensity of the second portion transmitted by the beamsplitter from the second location X₂ and generate a second electrical signal based on the optical intensity. The transimpedance amplifier is configured to amplify the second electrical signal. The data acquisition (DAQ) system is further configured to receive the amplified second electrical signal and detect a frequency f₂ at which an average power of the variably pulsed laser beam peaks due to stimulated amplification, by the first portion reflected from the beamsplitter from the second location X₂, of the variably pulsed laser beam generated by the laser diode. The computer system is configured to store the second location X₂ and the frequency f₂. The computer system is further configured to calculate the speed of light v based on:

$$v = 2 ( {X}_{2} - {X}_{1} ) / ( 1 / {f}_{2} - 1 / {f}_{1} ) .$$

In an aspect, the distance X₀ includes a portion of the laser diode, which is within a housing of the laser diode, where the computing device is configured to calculate the distance X₀ based on:

$${X}_{0} = \frac{1}{2} \times ( - ( {X}_{1} + {X}_{2} ) + ( {X}_{2 -} {X}_{1} ) \times ( ( {f}_{1} - {f}_{2} ) / ( {f}_{1} + {f}_{2} ) ) .$$

In an aspect, a distance between the distance X₀ and the position Xₚ is greater than or equal to about one meter and less than or equal to about two meters for a variable frequency pulse centered at about 80 MHz.

In an aspect, the variably pulsed laser beam has pulse width of 50 picoseconds.

In an aspect, the system includes an analog-to-digital converter located within the DAQ. The analog-to-digital converter is configured to convert the amplified second portion to a digital amplified second portion, and the DAQ system is configured to transmit the digital amplified second portion to the computing device.

In an aspect, the system includes an output terminal of the DAQ system configured transmit a voltage output signal generated by the DAQ system based on the amplified second portion, and a voltage controlled oscillator comprising an input voltage terminal configured to receive the voltage output signal. The voltage controlled oscillator is configured to generate a trigger output and transmit the trigger output to the laser driver.

In an aspect, the system includes a nuclear instrument module (NIM) sync signal generated by the laser driver, and a reshape and divide circuit configured to receive the NIM sync signal and convert the NIM sync signal to a low voltage transistor-to-transistor logic (TTL) sync signal.

In an aspect, the system includes a counter located in the DAQ. The counter is configured to receive the TTL sync signal from the reshape and divide circuit. The counter is configured to trigger the analog-to-digital converter of the DAQ to transmit the digital amplified second portion to the computing device based on the TTL sync signal.

In an aspect, the system includes the laser diode, the beamsplitter and the photodetector are arranged linearly, and the beamsplitter is positioned between the laser diode and the photodetector.

In an aspect, the system includes a mirror located on the linear stage at a position Xₘ from the beamsplitter. The beamsplitter is arranged at an angle in a range of zero degrees to forty five degrees with respect to the linear stage. The first portion is transmitted through the beamsplitter to the mirror and reflected back through the beamsplitter to the laser diode. The photodetector is located at a position perpendicular to the linear stage.

In an aspect, the system includes a first mirror located linearly with respect to the laser diode. The first mirror is tilted at forty five degrees, and a second mirror located perpendicularly to the first mirror in line with the linear stage. The second mirror is tilted at forty five degrees with respect to the linear stage. The variable frequency pulse generated by the laser diode is configured to reflect from the first mirror and reflect from the second mirror to the beamsplitter. The beamsplitter is configured to reflect the first portion back to the second mirror and the first mirror to the laser diode and transmit the second portion to the photodetector through the beamsplitter. The photodetector is located in line with the beamsplitter. The distance X₀ includes the portion of the laser diode, which is within the housing of the laser diode, a distance of the first mirror from the laser diode, a distance of the second mirror from the first mirror and a distance of the second mirror to the linear stage.

In another exemplary embodiment, a system for determining the speed of light includes a linear stage, a laser diode mounted at a distance X₀ from the linear stage, and a laser driver operatively connected to the laser diode. The laser driver is configured to generate a current having a variable frequency pulse. The laser diode is configured to receive the current having a variable frequency pulse, generate a variably pulsed laser beam and transmit the variably pulsed laser beam. The system includes a mirror mounted at a first location X₁ on the linear stage. The mirror is configured to receive the variably pulsed laser beam from the laser diode and reflect a portion of the variably pulsed laser beam back to the laser diode as feedback. The feedback generates stimulated amplification of the variably pulsed laser beam.

The system includes a photodetector configured to receive the amplified variably pulsed laser beam from the laser diode. The photodetector is configured to measure an optical intensity of the second portion transmitted by the mirror from the first location X₁ and generate a first electrical signal based on the optical intensity. The system includes a transimpedance amplifier connected to the photodetector. The transimpedance amplifier is configured to amplify the first electrical signal. The system includes a data acquisition (DAQ) system configured to receive the first amplified electrical signal and detect a frequency f₁ at which an average power of the variably pulsed laser beam peaks due to stimulated amplification, by the first portion reflected from the mirror from the first location X₁, of the variably pulsed laser beam generated by the laser diode. The system includes a computer system operatively connected to the DAQ system, wherein the computer system is configured to store the first location X₁ and the frequency f₁. The mirror is configured to be moved to a second location X₂ on the linear stage. The eye of the photodetector is configured to receive the second portion transmitted by the mirror from the second location X₂. The photodetector is configured to measure an optical intensity of the second portion transmitted by the mirror from the second location X₂ and generate a second electrical signal based on the optical intensity. The transimpedance amplifier is configured to amplify the second electrical signal. The data acquisition (DAQ) system is further configured to receive the amplified second electrical signal and detect a frequency f₂ at which an average power of the variably pulsed laser beam peaks due to stimulated amplification, by the first portion reflected from the mirror from the second location X₂, of the variably pulsed laser beam generated by the laser diode. The computer system is configured to store the second location X₂ and the frequency f₂. The computer system is further configured to calculate the speed of light v based on:

$$v = 2 ( {X}_{2} - {X}_{1} ) / ( 1 / {f}_{2} - 1 / {f}_{1} ) .$$

In an aspect, the distance X₀ includes a portion of the laser diode, which is within a housing of the laser diode, where the computing device is configured to calculate the distance X₀ based on:

$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$

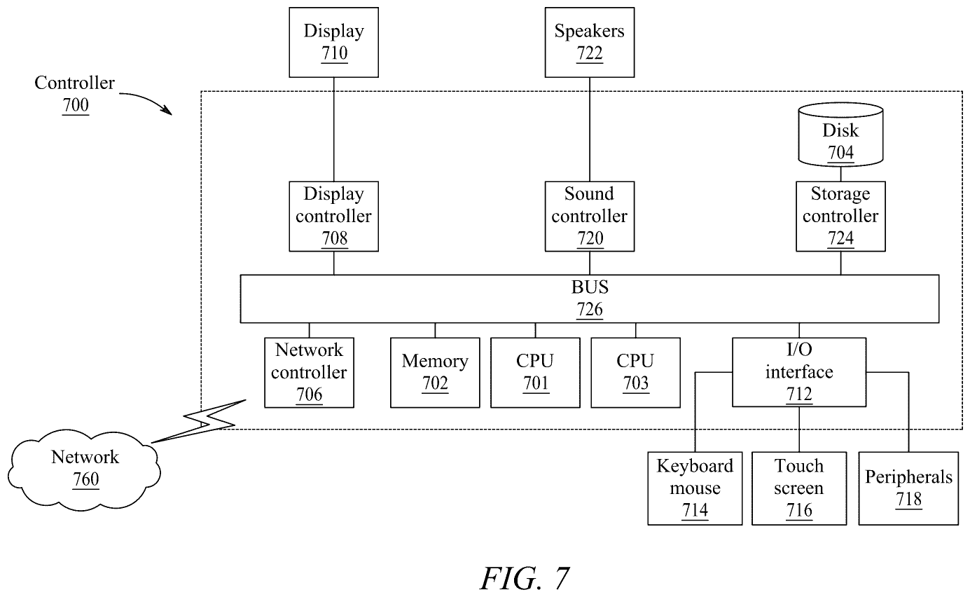

Next, further details of the hardware description of the computing environment according to exemplary embodiments is described with reference to FIG. 7. In FIG. 7, a controller 700 is described is representative of the PC 216 of the system 200 of FIG. 2 in which the controller is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 701, 703 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

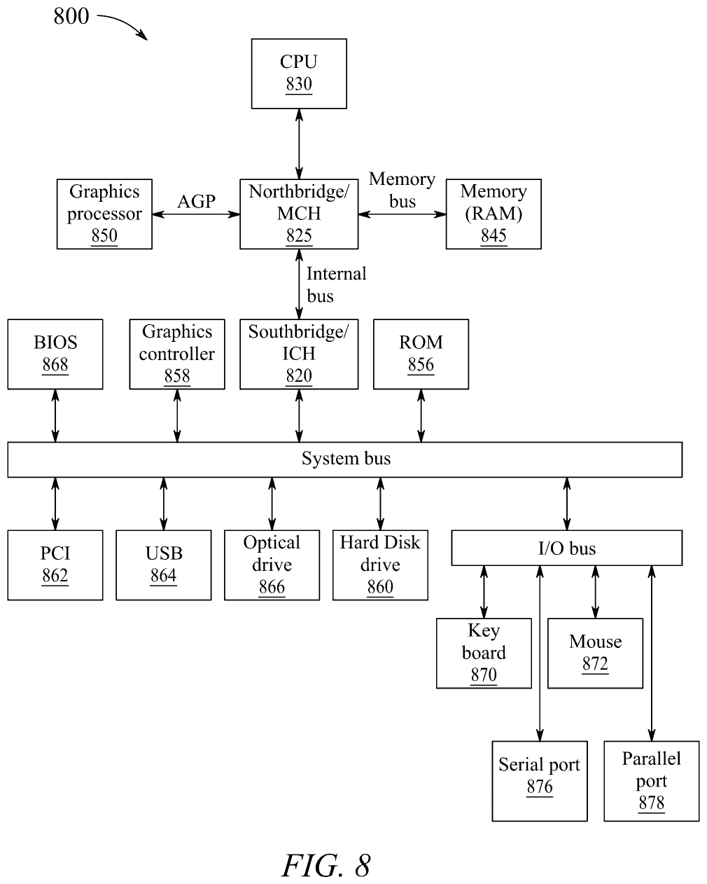

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

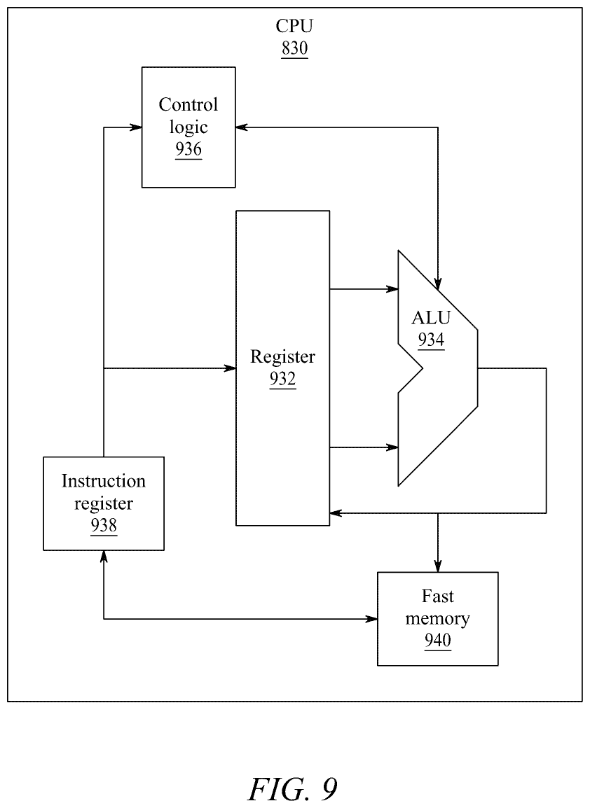

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

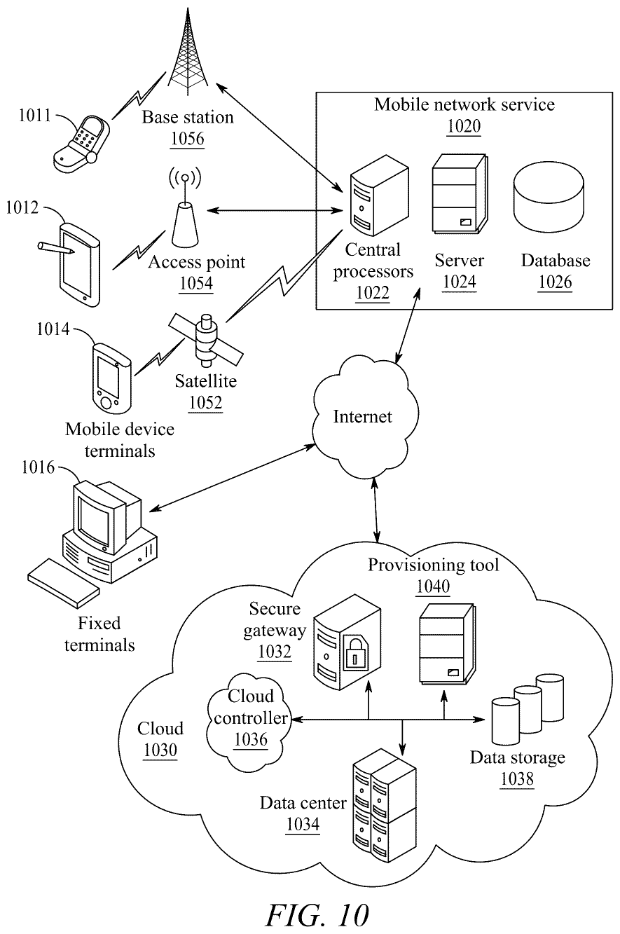

The functions and features described herein may also be executed by various distributed components of a system. For example, one or more processors may execute these system functions, wherein the processors are distributed across multiple components communicating in a network. The distributed components may include one or more client and server machines, such as cloud 1030 including a cloud controller 1036, a secure gateway 1032, a data center 1034, data storage 1038 and a provisioning tool 1040, and mobile network services 1020 including central processors 1022, a server 1024 and a database 1026, which may share processing, as shown by FIG. 10, in addition to various human interface and communication devices (e.g., display monitors 1016, smart phones 1010, tablets 1012, personal digital assistants (PDAs) 1014). The network may be a private network, such as a LAN, satellite 1052 or WAN 1054, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method for determining the speed of light, comprising:
mounting, at a distance X₀ from a linear stage, a laser diode;
mounting, at a first location X₁ on the linear stage, a beamsplitter;
mounting a photodetector at a distance Xₚ from the beamsplitter, wherein the beamsplitter is located between the laser diode and the photodetector and a center of the beamsplitter is in line with an eye of the photodetector;
connecting the laser diode to a laser driver;
generating, by the laser driver, a current having a variable frequency pulse;
driving, by the laser driver, the laser diode with the current having a variable frequency pulse;
generating, by the laser diode, a variably pulsed laser beam;
transmitting the variably pulsed laser beam to the beam splitter;
splitting, by the beam splitter, the variably pulsed laser beam into a first portion which is reflected from the beam splitter and a second portion which passes through the beam splitter;
receiving, by the laser diode, the first portion;
receiving, by the eye of the photodetector, the second portion;
measuring, by the photodetector, an optical intensity of second portion;
generating, by the photodetector, an electrical signal based on the optical intensity;
amplifying, by a transimpedance amplifier, the electrical signal;
receiving, by a data acquisition (DAQ) system, the amplified electrical signal;
detecting, by the data acquisition (DAQ) system, a frequency f₁ at which an average power of the variably pulsed laser beam peaks due to stimulated amplification, by the first portion reflected from the beamsplitter from the first location X₁, of the variably pulsed laser beam generated by the laser diode;
moving the beamsplitter to a second location X₂;
detecting, by the data acquisition (DAQ) system, a frequency f₂ at which the average power of the variably pulsed laser beam peaks due to stimulated amplification, by the first portion reflected from the beamsplitter from the second location X₂, of the variably pulsed laser beam generated by the laser diode; and
calculating, by a computing device connected to the DAQ system, the speed of light v based on:
$$v = 2 ( {X}_{2} - {X}_{1} ) / ( 1 / {f}_{2} - 1 / {f}_{1} ) .$$

2. The method for determining the speed of light of claim 1, further comprising:
calculating, by the computing device, the distance X₀ of the laser diode from the linear stage by:
$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$

3. The method for determining the speed of light of claim 1, wherein a distance between the distance X₀ and the position Xₚ is greater than or equal to about one meter and less than or equal to about two meters for a variable frequency pulse centered at about 80 MHz.

4. The method for determining the speed of light of claim 1, wherein the variably pulsed laser beam has pulse width of 50 picoseconds.

5. The method for determining the speed of light of claim 1, further comprising:
converting, by an analog-to-digital converter of the DAQ, the amplified second portion to a digital amplified second portion; and
transmitting the digital amplified second portion to the computing device.

6. The method for determining the speed of light of claim 5, further comprising:
generating, by the DAQ system, a voltage output signal configured to control the frequency of the variable frequency pulse;
receiving, at an input voltage terminal of a voltage controlled oscillator, the voltage output signal;
generating, by the voltage controlled oscillator, a trigger output; and
transmitting the trigger output to the laser driver.

7. The method for determining the speed of light of claim 6, further comprising:
generating, by the laser driver, a nuclear instrument module (NIM) sync signal;
transmitting, by the laser driver, the NIM sync signal to a reshape and divide circuit configured to convert the NIM sync signal to a low voltage transistor-to-transistor logic (TTL) sync signal.

8. The method for determining the speed of light of claim 7, further comprising:
receiving, by a counter located in the DAQ, the TTL sync signal from the reshape and divide circuit; and
triggering, by the counter, the analog-to-digital converter of the DAQ to transmit the digital amplified second portion to the computing device based on the TTL sync signal.

9. A system for determining the speed of light, comprising:
a linear stage;
a laser diode mounted at a distance X₀ from the linear stage, wherein the laser diode is configured to generate a variably pulsed laser beam;
a beamsplitter mounted at a first location X₁ on the linear stage, wherein the beamsplitter is configured to receive the variably pulsed laser beam from the laser diode;
a photodetector mounted at a distance Xₚ from the beamsplitter, wherein an eye of the photodetector is configured to receive a portion of the variably pulsed laser beam from the beamsplitter;
a laser driver operatively connected to the laser diode, wherein the laser driver is configured to generate a current having a variable frequency pulse, wherein the laser diode is configured to receive the current having a variable frequency pulse, generate a variably pulsed laser beam and transmit the variably pulsed laser beam to the beam splitter,
wherein the beamsplitter is configured to split the variably pulsed laser beam into a first portion which is reflected from the beam splitter back to the laser diode and a second portion which passes through the beam splitter and is transmitted to the photodetector,
wherein the eye of the photodetector is configured to receive the second portion transmitted from the beamsplitter from the first location X₁,
wherein the photodetector is configured to measure an optical intensity of the second portion transmitted by the beamsplitter from the first location X₁ and generate a first electrical signal based on the optical intensity;
a transimpedance amplifier connected to the photodetector, wherein the transimpedance amplifier is configured to amplify the first electrical signal;
a data acquisition (DAQ) system configured to receive the first amplified electrical signal and detect a frequency f₁ at which an average power of the variably pulsed laser beam peaks due to stimulated amplification, by the first portion reflected from the beamsplitter from the first location X₁, of the variably pulsed laser beam generated by the laser diode; and
a computing device operatively connected to the DAQ system, wherein the computing device is configured to store the first location X₁ and the frequency f₁,
wherein the beamsplitter is configured to be moved to a second location X₂,
wherein the beamsplitter at the second location X₂ is configured to split the variably pulsed laser beam into a first portion which is reflected from the beam splitter back to the laser diode and a second portion which passes through the beam splitter and is transmitted to the photodetector,
wherein the eye of the photodetector is configured to receive the second portion transmitted by the beamsplitter from the second location X₂,
wherein the photodetector is configured to measure an optical intensity of the second portion transmitted by the beamsplitter from the second location X₂ and generate a second electrical signal based on the optical intensity,
wherein the transimpedance amplifier is configured to amplify the second electrical signal,
wherein the data acquisition (DAQ) system is further configured to receive the amplified second electrical signal and detect a frequency f₂ at which an average power of the variably pulsed laser beam peaks due to stimulated amplification, by the first portion reflected from the beamsplitter from the second location X₂, of the variably pulsed laser beam generated by the laser diode,
wherein the computer system is configured to store the second location X₂ and the frequency f₂,
wherein the computer system is further configured to calculate the speed of light v based on:
$$v = 2 ( {X}_{2} - {X}_{1} ) / ( 1 / {f}_{2} - 1 / {f}_{1} ) .$$

10. The system of claim 9, further comprising a housing of the laser diode, wherein the distance X₀ includes a segment located within the laser diode, where the computing device is configured to calculate the distance X₀ based on:
$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$

11. The system of claim 9, wherein a distance between the distance X₀ and the position Xₚ is greater than or equal to about one meter and less than or equal to about two meters for a variable frequency pulse centered at about 80 MHz.

12. The system of claim 9, further comprising:
an analog-to-digital converter located within the DAQ, wherein the analog-to-digital converter is configured to convert the amplified second portion to a digital amplified second portion; and
the DAQ system is configured to transmit the digital amplified second portion to the computing device.

13. The system of claim 12, further comprising:
an output terminal of the DAQ system configured transmit a voltage output signal generated by the DAQ system based on the amplified second portion; and
a voltage controlled oscillator comprising an input voltage terminal configured to receive the voltage output signal,
wherein the voltage controlled oscillator is configured to generate a trigger output and transmit the trigger output to the laser driver.

14. The system of claim 13, further comprising:
a nuclear instrument module (NIM) sync signal generated by the laser driver;
a reshape and divide circuit configured to receive the NIM sync signal and convert the NIM sync signal to a low voltage transistor-to-transistor logic (TTL) sync signal.

15. The system of claim 14, further comprising:
a counter located in the DAQ, wherein the counter is configured to receive the TTL sync signal from the reshape and divide circuit, and
wherein the counter is configured to trigger the analog-to-digital converter of the DAQ to transmit the digital amplified second portion to the computing device based on the TTL sync signal.

16. The system of claim 9, wherein the laser diode, the beamsplitter and the photodetector are arranged linearly, and wherein the beamsplitter is positioned between the laser diode and the photodetector.

17. The system of claim 9, further comprising:
a mirror located on the linear stage at a position Xₘ from the beamsplitter;
wherein the beamsplitter is arranged at an angle in a range of zero degrees to forty five degrees with respect to the linear stage, wherein the first portion is transmitted through the beamsplitter to the mirror and reflected back through the beamsplitter to the laser diode, and
wherein the photodetector is located at a position perpendicular to the linear stage.

18. The system of claim 9, further comprising:
a first mirror located linearly with respect to the laser diode, wherein the first mirror is tilted at forty five degrees;
a second mirror located perpendicularly to the first mirror in line with the linear stage, wherein the second mirror is tilted at forty five degrees with respect to the linear stage;
wherein the variable frequency pulse generated by the laser diode is configured to reflect from the first mirror and reflect from the second mirror to the beamsplitter;
wherein the beamsplitter is configured to reflect the first portion back to the second mirror and the first mirror to the laser diode and transmit the second portion to the photodetector through the beamsplitter,
wherein the photodetector is located in line with the beamsplitter,
wherein the distance X₀ includes the portion of the laser diode which is within the housing of the laser diode, a distance of the first mirror from the laser diode, a distance of the second mirror from the first mirror and a distance of the second mirror to the linear stage.

19. A system for determining the speed of light, comprising:
a linear stage;
a laser diode mounted at a distance X₀ from the linear stage;
a laser driver operatively connected to the laser diode, wherein the laser driver is configured to generate a current having a variable frequency pulse, wherein the laser diode is configured to receive the current having a variable frequency pulse, generate a variably pulsed laser beam and transmit the variably pulsed laser beam;
a mirror mounted at a first location X₁ on the linear stage, wherein the mirror is configured to receive the variably pulsed laser beam from the laser diode and reflect a portion of the variably pulsed laser beam back to the laser diode as feedback, wherein the feedback generates stimulated amplification of the variably pulsed laser beam;
a photodetector configured to receive the amplified variably pulsed laser beam from the laser diode;
wherein the photodetector is configured to measure an optical intensity of the second portion transmitted by the mirror from the first location X₁ and generate a first electrical signal based on the optical intensity;
a transimpedance amplifier connected to the photodetector, wherein the transimpedance amplifier is configured to amplify the first electrical signal;
a data acquisition (DAQ) system configured to receive the first amplified electrical signal and detect a frequency f₁ at which an average power of the variably pulsed laser beam peaks due to stimulated amplification, by the first portion reflected from the mirror from the first location X₁, of the variably pulsed laser beam generated by the laser diode; and
a computer system operatively connected to the DAQ system, wherein the computer system is configured to store the first location X₁ and the frequency f₁, wherein the mirror is configured to be moved to a second location X₂ on the linear stage;
wherein the eye of the photodetector is configured to receive the second portion transmitted by the mirror from the second location X₂,
wherein the photodetector is configured to measure an optical intensity of the second portion transmitted by the mirror from the second location X₂ and generate a second electrical signal based on the optical intensity,
wherein the transimpedance amplifier is configured to amplify the second electrical signal,
wherein the data acquisition (DAQ) system is further configured to receive the amplified second electrical signal and detect a frequency f₂ at which an average power of the variably pulsed laser beam peaks due to stimulated amplification, by the first portion reflected from the mirror from the second location X₂, of the variably pulsed laser beam generated by the laser diode,
wherein the computer system is configured to store the second location X₂ and the frequency f₂,
wherein the computer system is further configured to calculate the speed of light v based on:
$$v = 2 ( {X}_{2} - {X}_{1} ) / ( 1 / {f}_{2} - 1 / {f}_{1} ) .$$

20. The system of claim 19, further comprising a housing of the laser diode, wherein the distance X₀ includes a portion located within the laser diode, where the computing device is configured to calculate the distance X₀ based on:
$${X}_{0} = \frac{1}{2} \times ( - ( {X}_{1} + {X}_{2} ) + ( {X}_{2} - {X}_{1} ) \times ( ( {f}_{1} - {f}_{2} ) / ( {f}_{1} + {f}_{2} ) ) .$$
